(19) United States
(12) Patent Application Publication
(10) Pub. No.: US 2011/0028177 A1
(43) Pub. Date: Feb. 3, 2011

(54) COMMUNICATION METHOD, BASE STATION APPARATUS USING THE SAME, AND COMMUNICATION SYSTEM

(75) Inventor: Yuki Nakasato, Gifu (JP)

Correspondence Address: MORRISON & FOERSTER LLP, 12531 HIGH BLUFF DRIVE, SUITE 100, SAN DIEGO, CA, 92130-2040, US

(73) Assignee: Kyocera Corporation, Kyoto (JP)

(21) Appl. No.: 12/864,495

(22) PCT Filed: Jan. 9, 2009
(86) PCT No.: PCT/JP2009/000084

§ 371 Date: Oct. 18, 2010

(30) Foreign Application Priority Data
Jan. 24, 2008 (JP) 2008-013639

(51) Int. Cl. H04B 7/00

(52) U.S. Cl. 455/509

(57) ABSTRACT

A base station apparatus is either of at least two types of base station apparatuses defined in a certain communication system. A ranging processing unit cyclically assigns control signals. The frequency of assigning control signals per unit time in the ranging processing unit is different from the frequency of assigning control signals per unit time in another type of base station apparatus. A modulator, a transmitter, and a radio unit broadcast an assigned control signal. The radio unit, the transmitter, the modulator, a receiver, and a demodulator perform communication with a terminal apparatus that has received a broadcasted control signal.

### TECHNICAL FIELD

The present invention relates to a wireless communication technique, and particularly to a communication method for assigning a control signal required to establish communication with a terminal apparatus, and a base station apparatus and communication system using the communication method.

### BACKGROUND ART

In mobile communication systems including second generation cordless telephone systems, a logical control channel (hereinafter, referred to as an “LCCH”) is defined. A base station apparatus (CS: Cell Station) assigns a time slot, which is a unit of communication, to a terminal apparatus (PS: Personal Station) so as to perform communication. When the number of group divisions is eight, a conventional LCCH consists of a broadcast control channel (hereinafter, referred to as a “BCCH”), eight paging channels (hereinafter, referred to individually as a “PCH”), and three signaling control channels (hereinafter, referred to individually as an “SCCH”), i.e., 12 channels in total. A base station apparatus transmits each channel intermittently at intervals of twenty frames (see Non-Patent Document 1, for example). One frame consists of eight time slots.

[Non-Patent Document 1] ARIB STANDARD RCR STD-28-1 “PERSONAL HANDY PHONE SYSTEM”, VERSION 4.1 (1/2)

### DISCLOSURE OF THE INVENTION

### [Problem to be Solved by the Invention]

In order to increase the communication capacity of a base station apparatus in a mobile communication system as described above, the base station apparatus performs Orthogonal Frequency Division Multiple Access (OFDMA). When there is an incoming call to a terminal apparatus, a base station apparatus transmits a PCH, including a number for identifying the terminal apparatus to which the incoming call is directed (hereinafter, such a number is referred to as a “terminal number”). Upon reception of the PCH, the terminal apparatus checks if the PCH includes the terminal number of the apparatus itself. If the PCH includes the terminal number, the terminal apparatus will transmit to the base station apparatus a request for initial ranging. Such a PCH, a request signal for initial ranging, and a BCCH are different from the data itself; these correspond to control information for establishing communication and are collectively referred to as control signals.

There may be provided two types of base station apparatuses: a microcell base station apparatus and a macrocell base station apparatus. The transmission power of a macrocell base station apparatus is defined to be higher than that of a microcell base station apparatus. Accordingly, the distance between macrocell base station apparatuses is generally larger than that between microcell base station apparatuses, and hence, macrocell base station apparatuses are less densely placed than microcell base station apparatuses.

It is assumed here that different frequencies are specified for a control signal for a macrocell base station apparatus and a control signal for a microcell base station apparatus (hereinafter, a frequency channel specified for a control signal is referred to as a “control channel”), and, within each of the two control channels thus specified, control signals for each base station apparatus are time-multiplexed. The occupancy rate of a control channel for a macrocell base station apparatus is lower than that of a control channel for a microcell base station apparatus. Consequently, the use efficiency of a control channel for a macrocell base station apparatus is lower than that of a control channel for a microcell base station apparatus.

The present invention has been made in view of such a situation, and a purpose thereof is to allow the use efficiencies of control channels for multiple types of base station apparatuses to be close to each other.

### [Means for Solving the Problem]

To solve the problems above, a base station apparatus of an embodiment of the present invention is either of at least two types of base station apparatuses defined in a predetermined communication system, and the base station apparatus comprises: an assigning unit configured to cyclically assign control signals; a broadcasting unit configured to broadcast a control signal assigned by the assigning unit; and a communication unit configured to perform communication with a terminal apparatus that has received a control signal broadcasted by the broadcasting unit. The frequency of assigning control signals per unit time in the assigning unit is different from the frequency of assigning control signals per unit time in another type of base station apparatus.

Another embodiment of the present invention is a communication system. The communication system comprises a first base station apparatus defined in a predetermined communication system, and a second base station apparatus defined in the same communication system in which the first base station apparatus is defined. The frequency of assigning control signals per unit time in the first base station apparatus is different from the frequency of assigning control signals per unit time in the second base station apparatus.

Yet another embodiment of the present invention is a communication method. The method comprises: assigning control signals cyclically in either of at least two types of base station apparatuses defined in a predetermined communication system; broadcasting an assigned control signal; and performing communication with a terminal apparatus that has received a broadcasted control signal. The frequency of assigning control signals per unit time in the assigning is different from the frequency of assigning control signals per unit time in another type of base station apparatus.

Optional combinations of the aforementioned constituting elements, and implementations of the invention in the form of methods, apparatuses, systems, recording media, and computer programs may also be practiced as additional modes of the present invention.

### ADVANTAGEOUS EFFECTS

The present invention allows the use efficiencies of control channels for multiple types of base station apparatuses to be close to each other.

### BRIEF DESCRIPTION OF THE DRAWINGS

FIG. 1 is a diagram that shows a configuration of a communication system according to an embodiment of the present invention;

FIG. 2 is a diagram that shows a configuration of a TDMA frame in the communication system shown in FIG. 1;

FIG. 3 is a diagram that shows a configuration of OFDMA subchannels in the communication system shown in FIG. 1;

FIG. 4 is a diagram that shows a configuration of subchannel blocks in the communication system shown in FIG. 1;

FIG. 5 is a diagram that shows a configuration of a logical control channel in the communication system shown in FIG. 1;

FIGS. 6A-6B are diagrams that show other configurations of logical control channels in the communication system shown in FIG. 2;

FIG. 7 is a diagram that shows a configuration of a base station apparatus shown in FIG. 1;

FIG. 8 is a diagram that shows a message format of a BCCH transmitted from the base station apparatus shown in FIG. 7;

FIG. 9 is a diagram that shows a message format of a PCH transmitted from the base station apparatus shown in FIG. 7;

FIGS. 10A-10B are diagrams that show time charts of step-by-step initial ranging performed by the base station apparatus shown in FIG. 7;

FIG. 11 is a diagram that shows a message format of an IRCH transmitted from the base station apparatus shown in FIG. 7;

FIG. 12 is a diagram that shows a message format of an RCH transmitted from the base station apparatus shown in FIG. 7;

FIG. 13 is a diagram that shows a message format of an SCCH transmitted from the base station apparatus shown in FIG. 7;

FIG. 14 is a sequential diagram that shows a procedure for establishing TCH synchronization in the communication system shown in FIG. 1; and

FIG. 15 is a diagram that shows a configuration of a logical control channel according to a modification of the present invention.

### EXPLANATION OF REFERENCE NUMERALS

1 base station apparatus

2 terminal apparatus

10 cell

20 communication system

50 network

52 control station

100 antenna

101 radio unit

102 transmitter

103 modulator

104 receiver

105 demodulator

106 IF unit

107 control unit

110 ranging processing unit

112 assigning unit

### BEST MODE FOR CARRYING OUT THE INVENTION

A general description will be given before the present invention is specifically described. An embodiment of the present invention relates to a communication system comprising a control apparatus, base station apparatuses, and terminal apparatuses. In the communication system, each frame consists of multiple time slots that are time-division multiplexed, and each time slot consists of multiple subchannels that are frequency-division multiplexed. Each subchannel is provided with a multicarrier signal. In the present embodiment, an OFDM signal is used as a multicarrier signal, and OFDMA is employed as frequency division multiplexing. A subchannel occupied by a control signal (hereinafter, referred to as a “control channel”) is defined separately from a subchannel occupied by a data signal. For example, a control channel is provided on the lowest-frequency subchannel within a frequency band designated for the communication system.

In the communication system, two types of base station apparatuses may be provided, such as a macrocell base station apparatus and a microcell base station apparatus, as stated previously, and a different control channel is specified for each type. In each control channel, control signals for multiple base station apparatuses are time-division multiplexed. Also, as mentioned previously, the use efficiency of a control channel for a macrocell base station apparatus is lower than that of a control channel for a microcell base station apparatus. In order to redress such a situation, the communication system according to the present embodiment performs processing as described below. Control signals for each base station apparatus are cyclically assigned with a predetermined period. The communication system defines the period with which control signals for a macrocell base station apparatus are assigned so that it becomes shorter than the period with which control signals for a microcell base station apparatus are assigned. Consequently, control signals for a macrocell base station apparatus are assigned more frequently than control signals for a microcell base station apparatus.

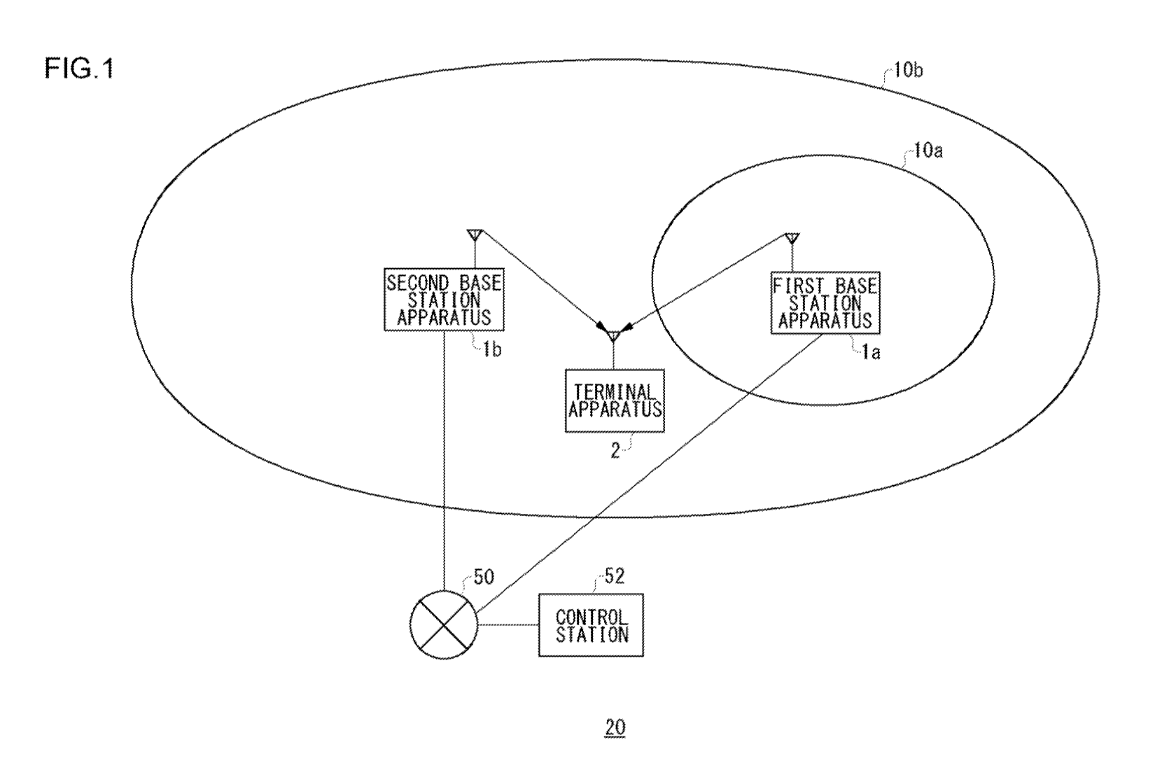

FIG. 1 shows a configuration of a communication system 20 according to the embodiment of the present invention. The communication system 20 includes: a first base station apparatus 1a and a second base station apparatus 1b, which are collectively referred to as base station apparatuses 1; a terminal apparatus 2; a network 50; and a control station 52.

As with in a second generation cordless telephone system, a base station apparatus 1 connects to multiple terminal apparatuses 2, not illustrated, using a TDMA-TDD (Time Division Multiple Access-Time Division Duplex) scheme. The first base station apparatus 1a corresponds to a macrocell base station apparatus set forth above and forms a first cell 10a, which is a macrocell. Also, the second base station apparatus 1b corresponds to a microcell base station apparatus set forth above and forms a second cell 10b, which is a microcell. The first cell 10a and the second cell 10b are collectively referred to as cells 10.

The communication system also includes other base station apparatuses 1, not illustrated, and the distance between base station apparatuses 1 is determined in consideration of the sizes of the cells 10. Since the first cell 10a is larger than the second cell 10b, the distance between macrocell base station apparatuses is longer than that between microcell base station apparatuses. Further, multiple cells 10 form a paging area, which is not illustrated. A control channel for a macrocell base station apparatus and a control channel for a microcell base station apparatus are placed on different frequencies. The first base station apparatus 1a assigns a control signal on a control channel for a microcell base station apparatus, and the second base station apparatus 1b assigns a control signal on a control channel for a macrocell base station apparatus.

The first base station apparatus 1a and second base station apparatus 1b assign control signals with different frequencies per unit time. That is, since the second cell 10b is larger than the first cell 10a, the second base station apparatus 1b assigns control signals more frequently within a unit time than the first base station apparatus 1a. This means that the period of assigning control signals in the second base station apparatus 1b is shorter than the period of assigning control signals in the first base station apparatus 1a.

The control station 52 is connected to base station apparatuses 1 via the network 50. The control station 52 performs location registration of a terminal apparatus 2. Location registration is performed to manage a paging area that includes a terminal apparatus 2. Since a publicly-known technique may be used therefor, a specific description of the location registration will be omitted here. The control station 52 also receives an incoming call notification for a terminal apparatus 2 using switching equipment or the like, which is not illustrated. The control station 52 then specifies the paging area that includes the terminal apparatus 2 for which the incoming call notification is provided, based on a result of the location registration. Thereafter, the control station 52 transmits the incoming call notification to a base station apparatus 1 that belongs to the paging area.

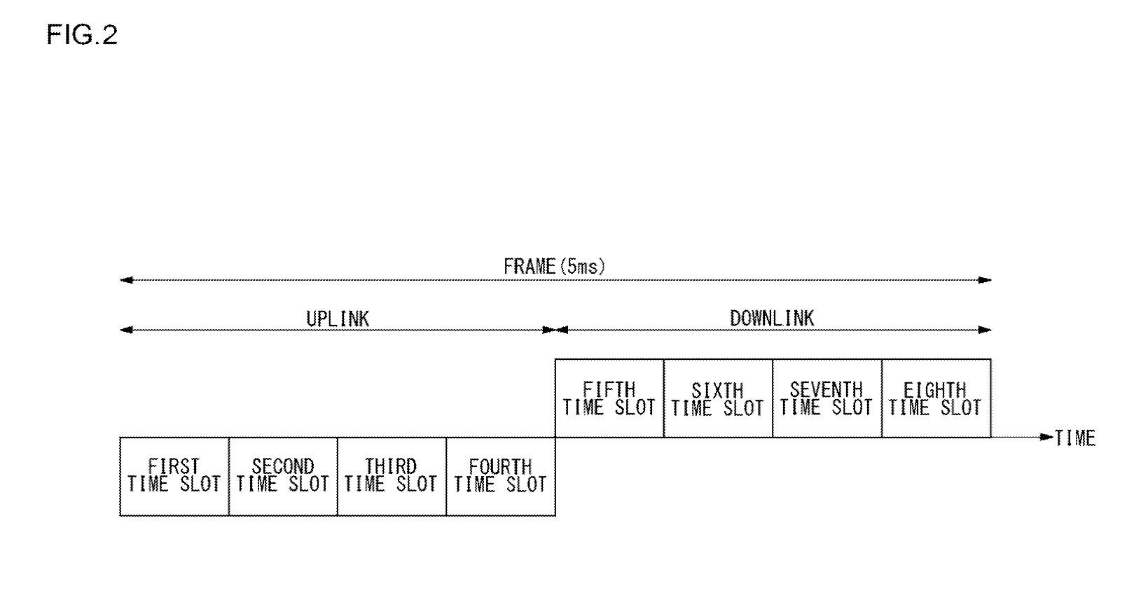

FIG. 2 shows a configuration of a TDMA frame in the communication system 20. A frame consists of four time slots for uplink communication and four time slots for downlink communication in the communication system 20, as with in a second generation cordless telephone system. Frames are successively arranged. In the present embodiment, the assignment of time slots for uplink communication is performed in the same way as the assignment of time slots for downlink communication. Accordingly, in the following, a description may be given only with regard to downlink communication for the sake of convenience.

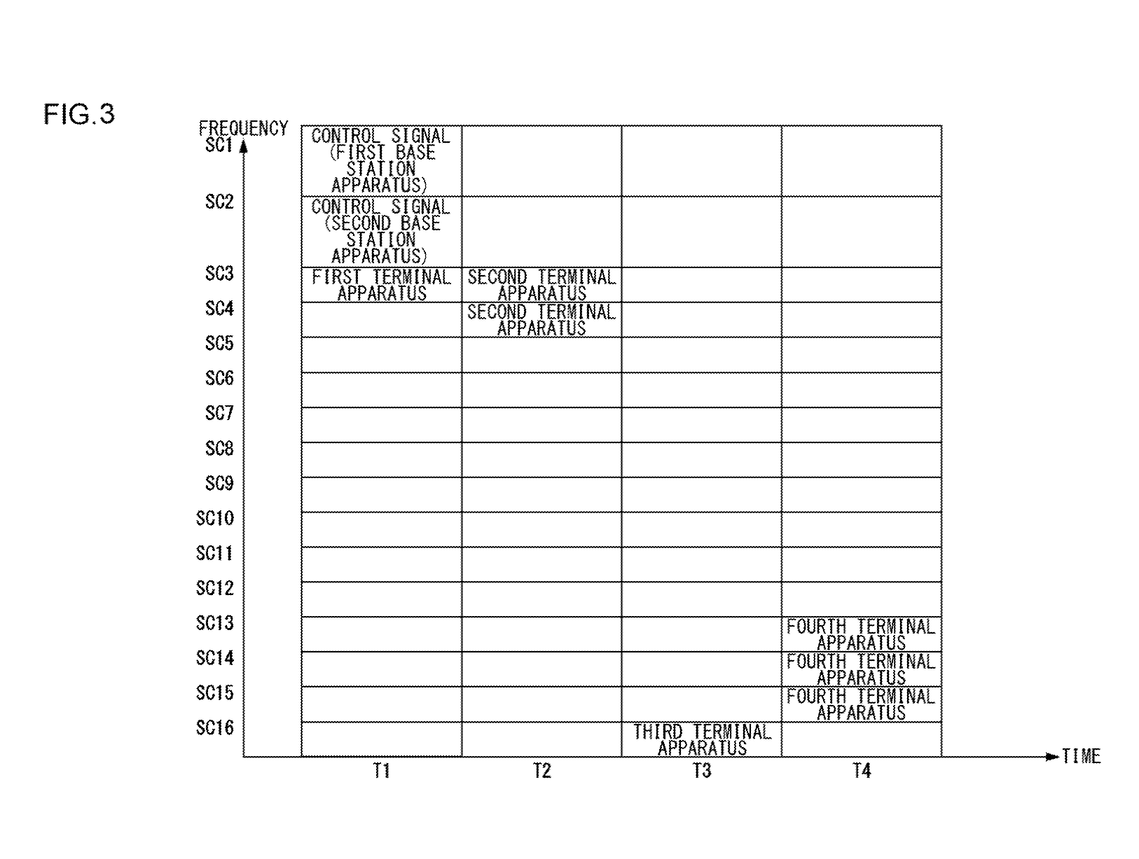

FIG. 3 shows a configuration of OFDMA subchannels in the communication system 20. Besides TDMA as described above, the base station apparatus 1 also applies OFDMA as shown in FIG. 3. Accordingly, multiple terminal apparatuses are assigned within a single time slot. In FIG. 3, the time slot arrangement is provided on a time axis in the direction of the horizontal axis, while the subchannel arrangement is provided on a frequency axis in the direction of the vertical axis. In other words, the multiplexing on the horizontal axis corresponds to TDMA, and the multiplexing on the vertical axis corresponds to OFDMA. FIG. 3 illustrates the first time slot (denoted by “T1” in the figure) through the fourth time slot (denoted by “T4” in the figure) included in a frame. For example, T1 through T4 in FIG. 3 correspond to the fifth through eighth time slots in FIG. 2, respectively.

Each time slot includes the first subchannel (denoted by “SC1” in the figure) through the sixteenth subchannel (denoted by “SC16” in the figure). In FIG. 3, the first subchannel is designated as a control channel for the first base station apparatus 1a, i.e., a microcell base station apparatus, while the second subchannel is designated as a control channel for the second base station apparatus 1b, i.e., a macrocell base station apparatus. In FIG. 3, the first base station apparatus 1a assigns a control signal to the first subchannel in the first time slot. When only SC1 is focused on, the frame configuration or a group of multiple frames corresponds to an LCCH. Meanwhile, the second base station apparatus 1b assigns a control signal to the second subchannel in the first time slot.

Also, in FIG. 3, a first terminal apparatus 2a is assigned to the third subchannel in the first time slot, and a second terminal apparatus 2b is assigned to the third and fourth subchannels in the second time slot. Furthermore, a third terminal apparatus 2c is assigned to the sixteenth subchannel in the third time slot, and a fourth terminal apparatus 2d is assigned to the thirteenth through fifteenth subchannels in the fourth time slot. Such subchannel assignment may be performed by the first base station apparatus 1a or the second base station apparatus 1b, and it is assumed here that the first base station apparatus 1a performs the subchannel assignment, for example.

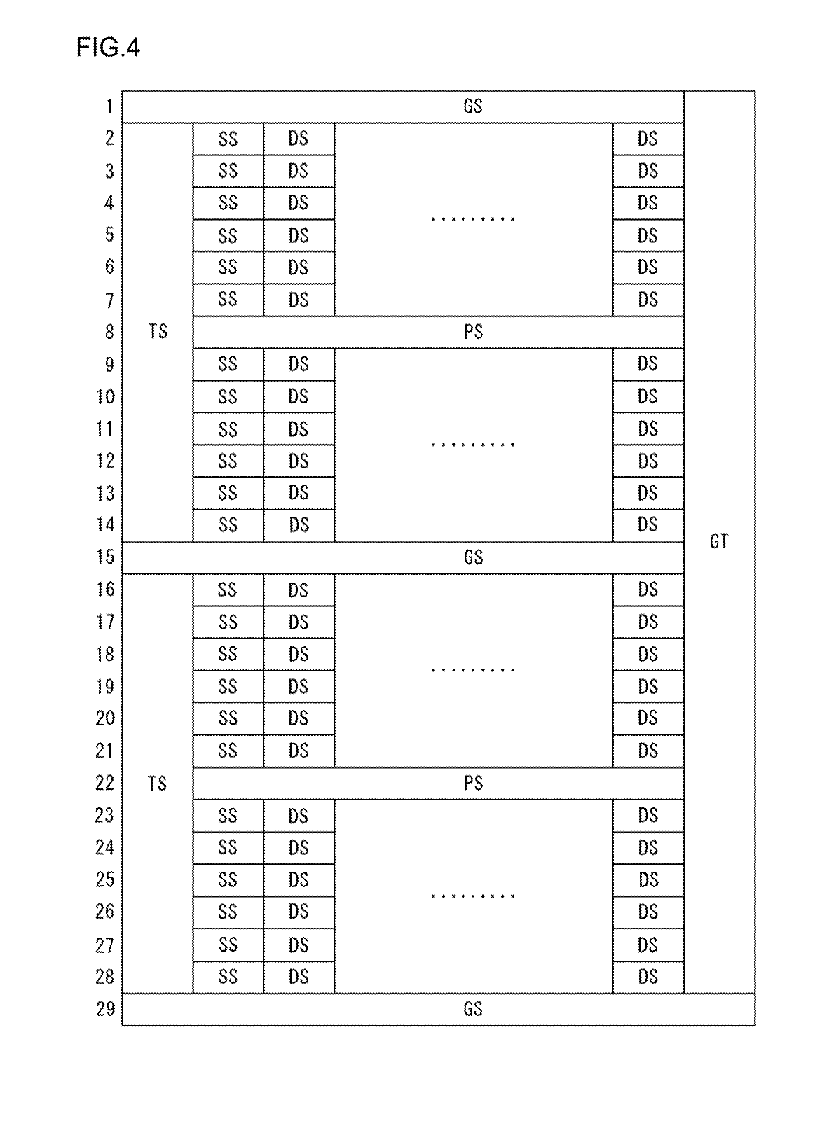

FIG. 4 shows a configuration of subchannel blocks in the communication system 20. A subchannel block corresponds to a radio channel specified by a time slot and a subchannel. In FIG. 4, the horizontal direction represents a time axis, while the vertical direction represents a frequency axis. The numbers “1” to “29” in the figure denote numbers of subcarriers. Thus, subchannels are provided with OFDM multicarrier signals. In FIG. 4, “TS” denotes a training symbol and includes a known signal such as an “STS”, a symbol for synchronization detection, and an “LTS”, a symbol for estimation of channel characteristics, both of which are not illustrated in the figure. The “GS” denotes a guard symbol in which no effective signal is provided. The “PS” denotes a pilot symbol, which is configured with a known signal. The “SS” denotes a signal symbol in which a control signal is provided. The “DS” denotes a data symbol that corresponds to data to be transmitted. The “GT” denotes guard time in which no effective signal is provided.

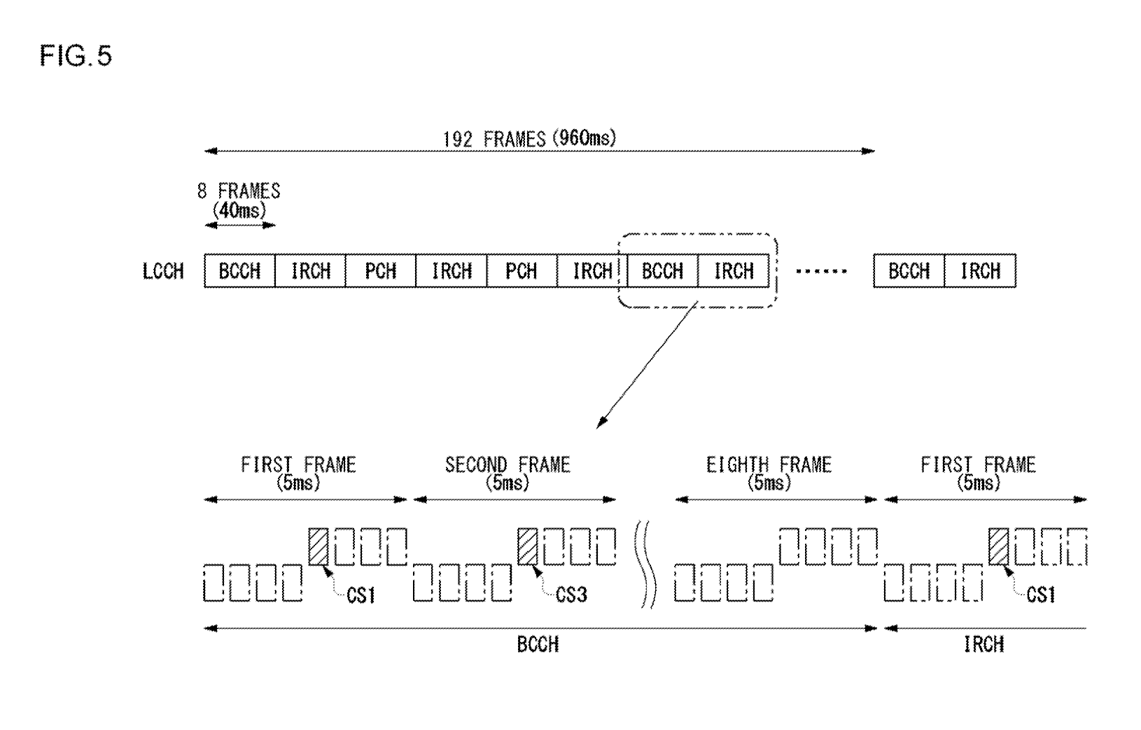

FIG. 5 shows a configuration of a logical control channel in the communication system 20. A logical control channel consists of four BCCHs, twelve IRCHs, and eight PCHs, i.e., 24 channels in total. Each of the BCCHs, IRCHs, and PCHs consists of eight TDMA frames (hereinafter, simply referred to as “frames”). One frame is configured as shown in FIG. 2. In FIG. 5, frames provided for a PCH, a BCCH, or an IRCH are also represented by “PCH”, “BCCH”, or “IRCH” for the sake of convenience. Also, although a frame is divided into multiple time slots, as stated previously, the term “PCH”, “BCCH”, or “IRCH” is used regardless of the unit of a time slot, a frame, or eight frames.

In the figure, “IRCH” is a channel for initial ranging used in channel assignment. Technically, “IRCH” includes “TCCH” and “IRCH”, and the “TCCH” corresponds to a request for initial ranging transmitted from a terminal apparatus 2 to a base station apparatus 1. The “IRCH” corresponds to a response to such a request for initial ranging. Therefore, “TCCH” is an uplink signal, and “IRCH” is a downlink signal (hereinafter, the combination of a TCCH and an IRCH will be also referred to as an IRCH, with no distinction from an IRCH alone). The base station apparatus that has received a TCCH from a terminal apparatus performs ranging processing. Since a publicly-known technique may be used for such processing, a specific description thereof will be omitted here.

In the lower part of the figure, the configuration of each frame is illustrated similarly to that in FIG. 2. This configuration also corresponds to the frame configuration in SC1 in FIG. 4. The first base station apparatus 1a of FIG. 1 transmits each of BCCHs, IRCHs, and PCHs intermittently at intervals of eight frames, using a time slot assigned for the LCCH (denoted by “CS1” in the figure) among time slots constituting the frame. More specifically, the first base station apparatus 1a uses the fifth time slot in the first frame among eight frames constituting a BCCH and also uses the fifth time slot in the first frame among eight frames constituting an IRCH.

Further, the first base station apparatus 1a uses the fifth time slot in the first frame among eight frames constituting a PCH. A third base station apparatus 1c, not illustrated in FIG. 1, is a microcell base station apparatus. The third base station apparatus 1c transmits each of BCCHs, IRCHs, and PCHs intermittently at intervals of eight frames, using, among the time slots in the frame subsequent to the frame used by the first base station apparatus 1a (the second frame in the figure), a time slot of which the position within a frame is identical with that of a time slot used by the first base station apparatus 1a (the subject time slot is denoted by “CS3” in the figure). With such a configuration, the number of base station apparatuses for which signals can be multiplexed is four downlink time slots in a frame multiplied by eight, i.e., 32 base station apparatuses at the maximum.

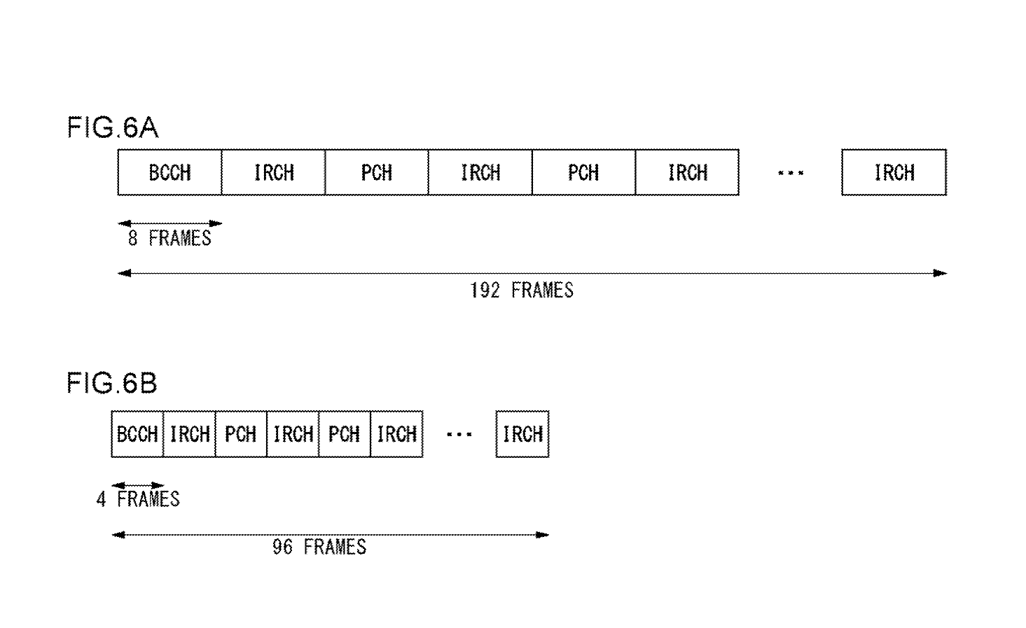

FIGS. 6A-6B show other configurations of logical control channels in the communication system 20 shown in FIG. 2. FIG. 6A shows a configuration of an LCCH for a microcell base station apparatus and is identical with the upper part of FIG. 5. In this case, a unit of a BCCH, an IRCH, a PCH, an IRCH, a PCH, and an IRCH (hereinafter, referred to as a “repeat unit”) is repeated four times, thereby forming an LCCH. Since a BCCH or another channel consists of eight frames, an LCCH contains 192 frames. LCCHs are also repeatedly arranged. Signals can be multiplexed for up to 32 base station apparatuses, as mentioned previously.

FIG. 6B shows a configuration of an LCCH for a macrocell base station apparatus. As shown in the figure, each of BCCHs, IRCHs, and PCHs consists of four frames, which are fewer than in the case of a microcell base station apparatus. A microcell base station apparatus assigns a control signal once every eight frames, while a macrocell base station apparatus assigns a control signal once every four frames. That is, the period of a macrocell base station apparatus's assigning control signals is shorter than the period of a microcell base station apparatus's assigning control signals. A repeat unit is also defined for a macrocell base station apparatus in the same way as for a microcell base station apparatus and is repeated four times to form an LCCH.

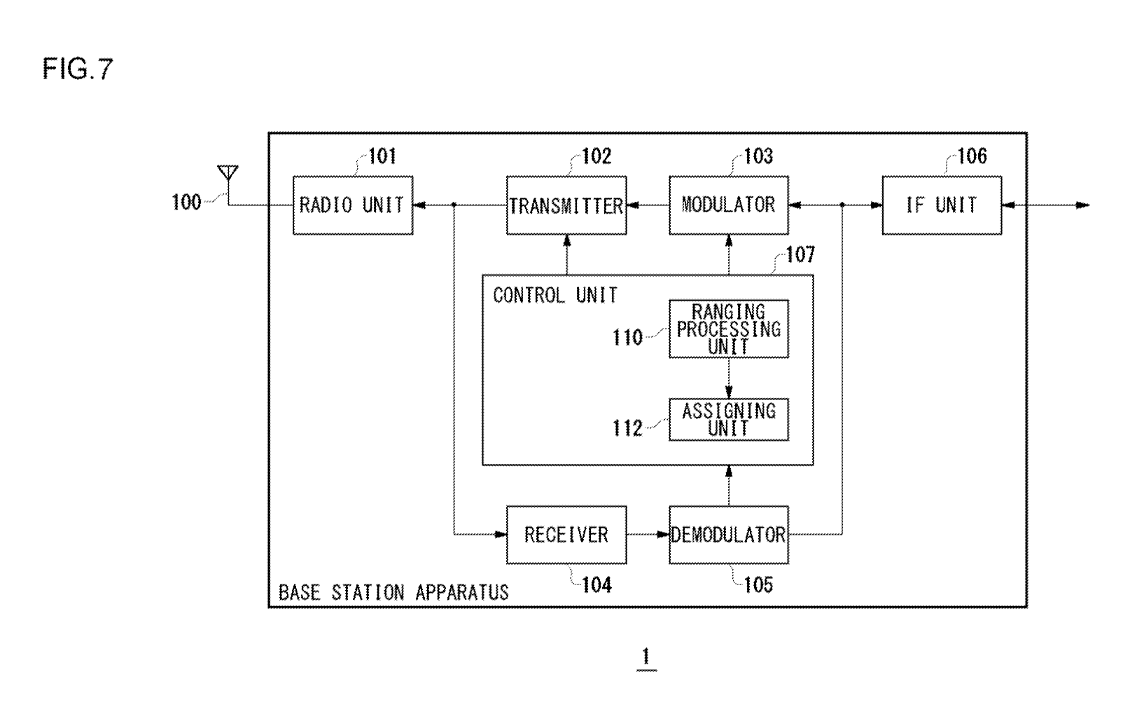

FIG. 7 shows a configuration of a base station apparatus 1. The base station apparatus 1 comprises an antenna 100, a radio unit 101, a transmitter 102, a modulator 103, a receiver 104, a demodulator 105, an IF unit 106, and a control unit 107. The control unit 107 includes a ranging processing unit 110 and an assigning unit 112. The base station apparatus 1 is either of the two types of base station apparatuses 1 defined in the communication system 20 shown in FIG. 1, i.e., a microcell base station apparatus or a macrocell base station apparatus.

The antenna 100 transmits and receives a radio frequency signal. To the radio frequency signal here, the theory of FIGS. 2 through 4 can be applied. As reception processing, the radio unit 101 converts the frequency of a radio frequency signal received by the antenna 100 to derive a baseband signal and outputs the resulting signal to the receiver 104. Also, as transmission processing, the radio unit 101 converts the frequency of a baseband signal transmitted by the transmitter 102 to derive a radio frequency signal and outputs the resulting signal to the antenna 100.

The transmission power of the radio unit 101 differs depending on whether the base station apparatus 1 is a microcell base station apparatus or a macrocell base station apparatus. More specifically, the transmission power of the radio unit 101 in a macrocell base station apparatus is higher than that of the radio unit 101 in a microcell base station apparatus. Although a baseband signal should be indicated by two signal lines because it generally consists of an in-phase component and a quadrature component, the signal is indicated by a single signal line in the figure in the interest of clarity.

The transmitter 102 converts a frequency domain signal transmitted by the modulator 103 into a time domain signal and outputs the resulting signal to the radio unit 101. For the conversion from a frequency domain signal into a time domain signal, an IFFT (Inversed Fast Fourier Transform) is used. The modulator 103 modulates an input from the IF unit 106 and outputs the resulting signal to the transmitter 102. As a modulation scheme therefor, BPSK (Binary Phase Shift Keying), QPSK (Quadrature Phase Shift Keying), 16QAM (Quadrature Amplitude Modulation), 64QAM, 256QAM, or the like is used.

The receiver 104 converts a time domain signal transmitted by the radio unit 101 into a frequency domain signal and outputs the resulting signal to the demodulator 105. For the conversion from a time domain signal into a frequency domain signal, an FFT (Fast Fourier Transform) is used. The demodulator 105 demodulates an input from the receiver 104 and outputs the resulting signal to the IF unit 106. On this occasion, demodulation corresponding to the modulation is performed. The IF unit 106 is connected to a network 50, not illustrated, and outputs to the network 50, as reception processing, a signal demodulated by the demodulator 105. Also, as transmission processing, the IF unit 106 receives data from the network 50 and outputs it to the modulator 103. Furthermore, the IF unit 106 accepts an incoming call notification from the control station 52, not illustrated, via the network 50, also not illustrated. The IF unit 106 then outputs the incoming call notification thus accepted to the control unit 107.

The control unit 107 performs the overall timing control for the base station apparatus 1. The control unit 107 also configures an LCCH as shown in FIG. 5 or FIGS. 6A-6B and intermittently transmits it to a terminal apparatus 2. The ranging processing unit 110 controls the times at which LCCHs including BCCHs are sequentially transmitted through the modulator 103, transmitter 102, radio unit 101, and antenna 100. The ranging processing unit 110 cyclically assigns LCCHs, which are control signals, to a predetermined subchannel, i.e., a control channel. If the base station apparatus 1 is a microcell base station apparatus, the ranging processing unit 110 will use the first subchannel as the control channel. If the base station apparatus 1 is a macrocell base station apparatus, on the other hand, the ranging processing unit 110 will use the second subchannel as the control channel.

The ranging processing unit 110 also cyclically selects a time slot in a control channel and assigns an LCCH to the time slot thus selected. For the selection of a time slot, a publicly-known technique may be used; for example, the receiver 104 may measure the amount of interference power in each time slot, and the ranging processing unit 110 may then select a time slot with the minimum interference power. The frequency of the LCCH assignment within a unit time differs depending on whether the base station apparatus 1 is a microcell base station apparatus or a macrocell base station apparatus. The unit time here corresponds to a repeat unit or 192 frames, for example. If the base station apparatus 1 is a microcell base station apparatus, the ranging processing unit 110 will assign an LCCH to a time slot within eight frames, as shown in FIG. 5 and FIG. 6A. The ranging processing unit 110 assigns, as an LCCH, a BCCH, an IRCH, a PCH, an IRCH, a PCH, and an IRCH in this order.

On the other hand, if the base station apparatus 1 is a macrocell base station apparatus, the ranging processing unit 110 will assign an LCCH to a time slot within four frames, as shown in FIG. 6B. That is, the ranging processing unit 110 in a macrocell base station apparatus determines the period of LCCH assignment so that it becomes shorter than the period of LCCH assignment in a microcell base station apparatus 1. More specifically, the ranging processing unit 110 in a macrocell base station apparatus determines the period of LCCH assignment so that it becomes an integer fraction of the period of LCCH assignment in a microcell base station apparatus 1. The integer fraction should preferably be “the reciprocal of a power of two”, such as “½”. Other examples may be “¼” and “⅛”.

The ranging processing unit 110 allows the modulator 103, transmitter 102, and radio unit 101 to broadcast an assigned LCCH. On this occasion, a subchannel to be assigned the LCCH differs depending on whether the base station apparatus 1 is a microcell base station apparatus or a macrocell base station apparatus, as stated previously. This corresponds to the frequency to be used being different. For example, if the base station apparatus 1 is a microcell base station apparatus, the ranging processing unit 110 will assign the LCCH to the first subchannel, as shown in FIG. 3. If the base station apparatus 1 is a macrocell base station apparatus, on the other hand, the ranging processing unit 110 will assign the LCCH to the second subchannel, also as shown in FIG. 3.

Furthermore, the transmission power used to broadcast an LCCH also differs depending on whether the base station apparatus 1 is a microcell base station apparatus or a macrocell base station apparatus. Since the transmission power of the radio unit 101 in a macrocell base station apparatus is higher than that of the radio unit 101 in a microcell base station apparatus, an LCCH from a macrocell base station apparatus is broadcasted with higher transmission power than an LCCH from a microcell base station apparatus. The ranging processing unit 110 generates a PCH as an incoming call signal based on an incoming call notification received by the IF unit 106. The ranging processing unit 110 then broadcasts the PCH through the modulator 103, transmitter 102, radio unit 101, and antenna 100.

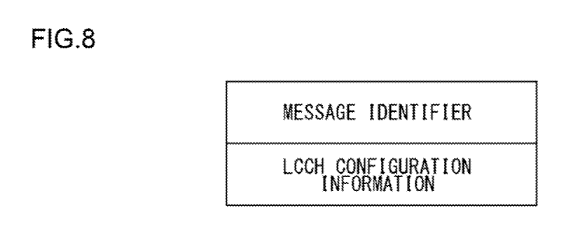

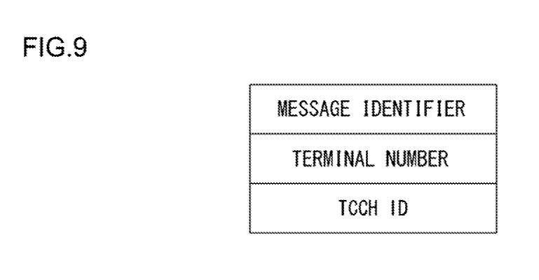

FIG. 8 shows a message format of a BCCH transmitted from a base station apparatus 1. A BCCH includes a message identifier for identifying the type of the message, and LCCH configuration information that specifies a parameter for defining the configuration of the logical control channel, such as an interval value, paging groups, and a battery saving cycle maximum value. FIG. 9 shows a message format of a PCH transmitted from a base station apparatus 1. A PCH includes a message identifier for identifying the type of the message, and the number of a terminal apparatus to which an incoming call has been provided. The PCH also includes a TCCH ID. Upon reception of a PCH as the notification of an incoming call, a terminal apparatus 2 requests initial ranging from the base station apparatus 1 that has sent the PCH. The description will now return to FIG. 7.

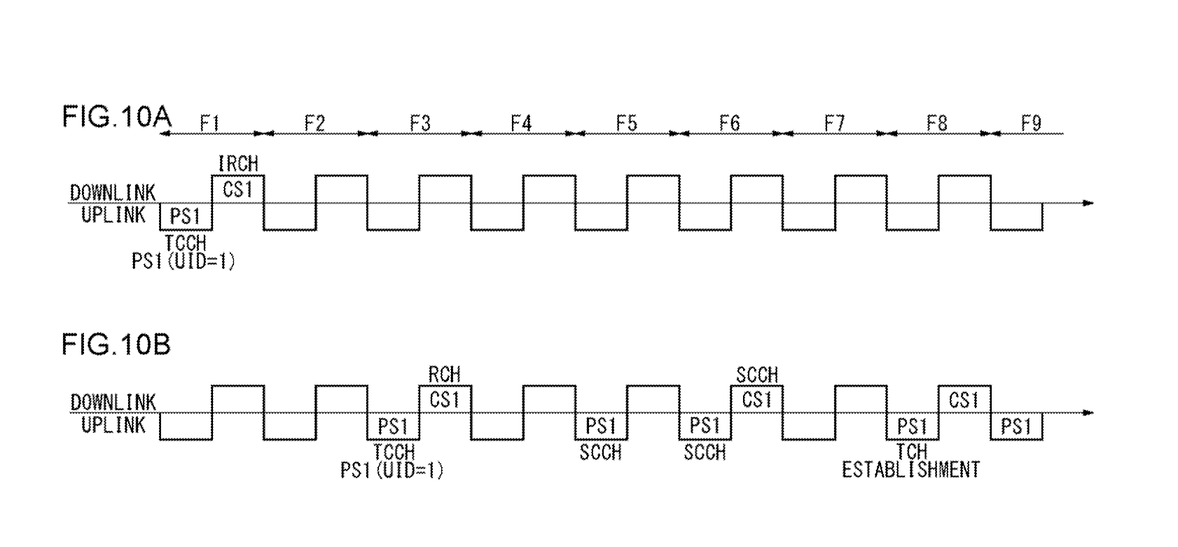

Upon reception of a TCCH from a terminal apparatus 2, the ranging processing unit 110 adjusts the transmission power or the timing of transmission for the terminal apparatus 2 using a publicly-known technique. The ranging processing unit 110 then repeatedly provides a ranging response including the adjustment result, such as performing ranging processing of transmitting an IRCH, multiple times. Such processing will be detailed using FIGS. 10A-10B. FIGS. 10A-10B show time charts of step-by-step initial ranging performed by a base station apparatus 1. The frames are assigned numbers serially from top to bottom for the sake of convenience, and the frames 1 through 9 are denoted by “F1” through “F9”. Also, in the interest of clarity, FIGS. 10 only depict the first time slot in each of the uplink and downlink within each frame shown in FIG. 2.

For example, if the base station apparatus 1 is a microcell base station apparatus, the ranging processing unit 110 will define the timing of first receiving a TCCH and transmitting an IRCH using a frequency band to which a PCH or a BCCH for each base station apparatus 1 is cyclically assigned, i.e., SC1 in FIG. 3, as described previously. FIG. 10A shows the operation in SC1. A terminal apparatus 2 receives a BCCH, not illustrated, and identifies a base station apparatus 1 to connect to. The terminal apparatus 2 then transmits a TCCH in F1. The terminal apparatus 2 may receive a PCH, and in such a case, the terminal apparatus 2 receives the PCH before receiving the BCCH.

There are defined multiple kinds of waveform patterns for TCCHs. More specifically, a waveform pattern is defined when part of multiple subcarriers are selected; therefore, by changing the subcarrier to be selected, multiple kinds of waveform patterns are defined. Accordingly, even when simultaneously receiving TCCHs from multiple terminal apparatuses 2, the ranging processing unit 110 can distinguish between the terminal apparatuses 2 as long as the waveform patterns of the TCCHs are different from each other. In other words, the collision probability of TCCHs can be reduced. A terminal apparatus 2, not illustrated, randomly selects one of the multiple kinds of waveform patterns thus defined.

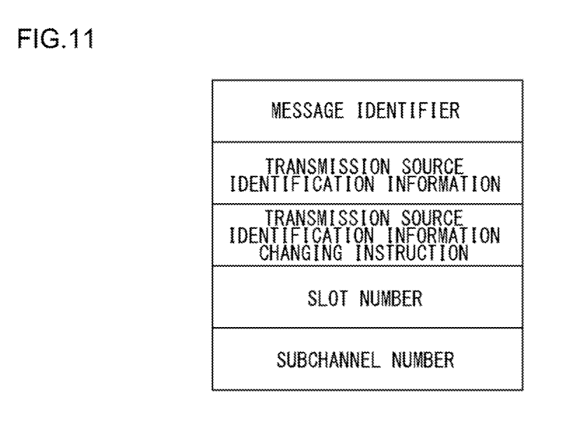

FIG. 11 shows a message format of an IRCH transmitted from a base station apparatus 1. An IRCH includes a message identifier for identifying the type of the message, information for identifying a transmission source that has requested initial ranging, a transmission source identification information changing instruction for ordering the change of the transmission source identification information to a value different from the value specified at the time of the first initial ranging request, and information (a slot number and a subchannel number) for specifying a data transfer channel (hereinafter, referred to as a TCH) on which the second TCCH is to be transmitted. A TCH is assigned to a subchannel other than SC1 or SC2 in FIG. 3. In the following, a communication channel used for communication will be also referred to as a TCH, but the term “TCH” is used with no distinction. The transmission source identification information is a value predetermined so that, even when initial ranging requests are simultaneously transmitted from multiple terminal apparatuses 2, the base station apparatus 1 can distinguish between the terminal apparatuses 2 by performing a predetermined operation on the value. The description will now return to FIG. 10B.

The ranging processing unit 110 defines the timing of receiving the second or a subsequent TCCH from the terminal apparatus 2, in the previous ranging response, such as the IRCH. The ranging processing unit 110 defines the timing of receiving the second or a subsequent TCCH and transmitting the second or a subsequent ranging response using a frequency band to which a TCH for each base station apparatus 1 is adaptively assigned, such as each of SC3 through SC16 in FIG. 3. FIG. 10B corresponds to a time chart of the operation in a subchannel specified by the IRCH, and the ranging processing unit 110 receives a TCCH and transmits an RCH as a ranging response thereto in F3.

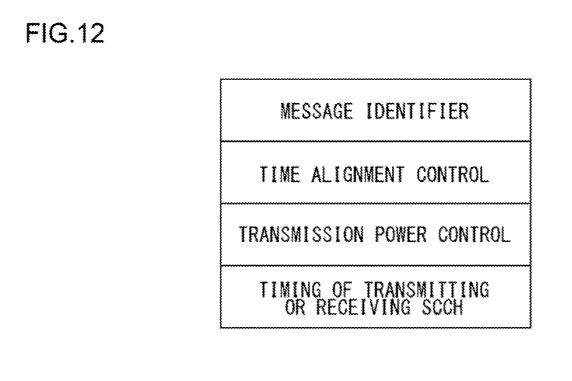

FIG. 12 shows a message format of an RCH transmitted from a base station apparatus 1. An RCH includes a message identifier for identifying the type of the message, control information for synchronization (timing alignment control and transmission power control), and a timing of transmitting or receiving an SCCH, which specifies the time of initiation of a request for radio resource allocation. The terminal apparatus 2 adjusts the time difference by timing alignment control and adjusts the transmission power by transmission power control so as to achieve synchronization with the base station apparatus 1 before requesting radio resource allocation. The description will now return to FIG. 10B.

It is assumed here that F5 and F6 are specified by the RCH to transmit and receive SCCHs, as shown in FIG. 10B. After the ranging processing unit 110 completes ranging processing, the assigning unit 112 shown in FIG. 7 receives an SCCH from the terminal apparatus 2, not illustrated, and assigns a communication channel TCH to the terminal apparatus 2 accordingly. The assigning unit 112 then transmits, in F5 shown in FIG. 10B, an SCCH including the assignment result. Thus, the assigning unit 112 performs channel assignment for a terminal apparatus 2 to which an IRCH has been transmitted, using a frequency band other than that to which the ranging processing unit 110 assigns a BCCH, a PCH, or the like.

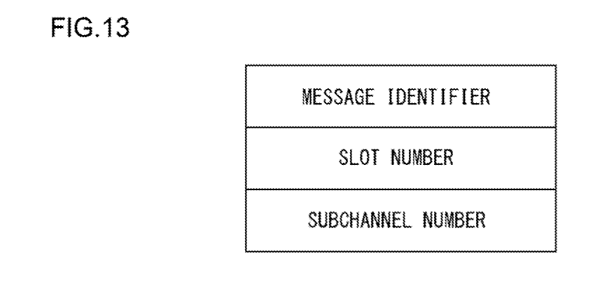

FIG. 13 shows a message format of an SCCH transmitted from a base station apparatus 1. An SCCH includes a message identifier for identifying the type of the message, and information (a slot number and a subchannel number) for specifying a TCH assigned to the terminal apparatus 2. In this way, an initial ranging request is processed step by step; the base station apparatus responds to the first initial ranging request using an LCCH, and, thereafter, the apparatus responds to the second initial ranging request and radio resource allocation request using a TCH. Accordingly, channel assignment for multiple terminal apparatuses can be performed at the same time, and the terminal apparatuses can be accurately distinguished without preparing multiple pieces of transmission source identification information. The description will now return to FIG. 10B. It is assumed here that a TCH after F8 is specified by the SCCH, as shown in FIG. 10B. After the assigning unit 112 assigns the TCH, the control unit 107 starts communication with the terminal apparatus 2.

The configuration above may be implemented by a CPU or the memory of any given computer, an LSI, or the like in terms of hardware, and by a memory-loaded program having a communication function or the like in terms of software. In the present embodiment is shown a functional block configuration realized by cooperation thereof. Therefore, it would be understood by those skilled in the art that these functional blocks may be implemented in a variety of forms by hardware only, software only, or a combination thereof.

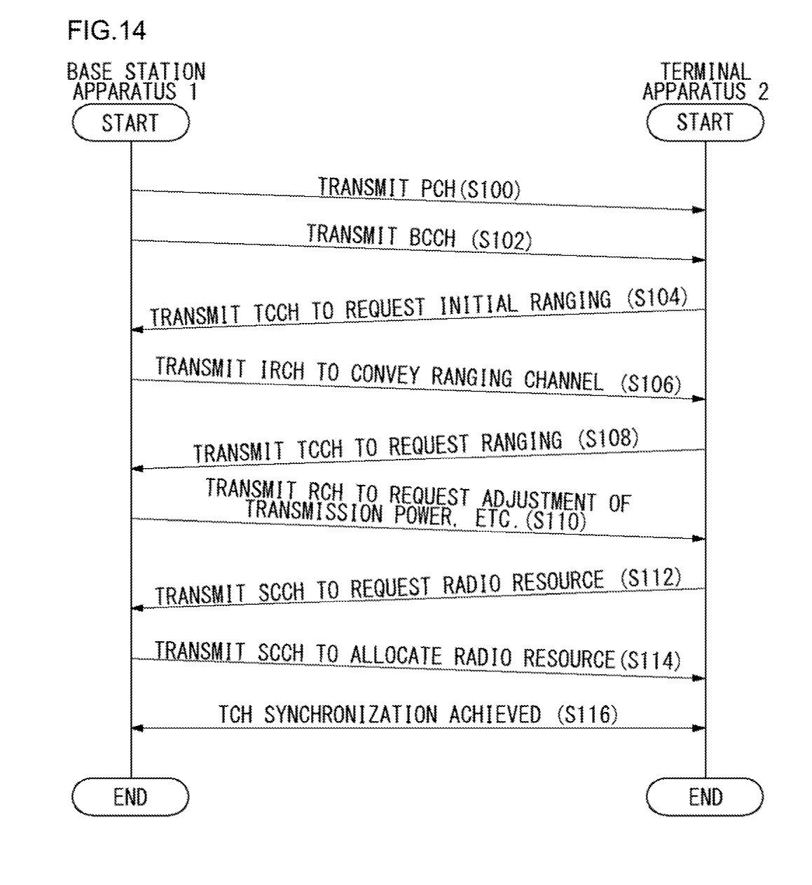

There will now be described the operation performed by the communication system 20 having the configuration set forth above. FIG. 14 is a sequential diagram that shows a procedure for establishing TCH synchronization in the communication system 20. A base station apparatus 1 includes the terminal number of a terminal apparatus 2 in a PCH and transmits the PCH at the same time as other base station apparatuses belonging to the paging area transmit PCHs (S100). The base station apparatus 1 then transmits a BCCH at a predetermined timing (S102). When a terminal apparatus 2 receives the PCH and learns that the PCH includes the terminal number of the apparatus itself, the terminal apparatus 2 identifies the base station apparatus 1 based on the BCCH, includes transmission source identification information in a TCCH, and transmits the TCCH to the base station apparatus CS1, thereby requesting the first initial ranging (S104). The base station apparatus CS1 then separates the transmission source identification information UID of the terminal apparatus 2 from the received TCCH and assigns the terminal apparatus 2 to an unoccupied TCH.

Thereafter, the base station apparatus includes, in an IRCH, the slot number and subchannel number of the TCH thus assigned and transmits the IRCH to the terminal apparatus 2, thereby notifying the terminal apparatus 2 of the TCH on which the second initial ranging will be performed (S106). The terminal apparatus 2 then includes transmission source identification information in a TCCH and transmits the TCCH to the base station apparatus 1 using the TCH assigned for initial ranging, thereby requesting the second initial ranging (S108). Subsequently, the base station apparatus 1 performs ranging processing using the TCH assigned for the terminal apparatus 2. The base station apparatus 1 then includes, in an RCH, time alignment control, transmission power control, and the timing of transmitting and receiving SCCHs, and transmits the RCH to the terminal apparatus 2, thereby requesting adjustment of transmission power, etc. (5110). Accordingly, the terminal apparatus 2 extracts from the received RCH an adjustment value required by the base station apparatus 1 and adjusts the transmission power, etc.

Thereafter, the terminal apparatus 2 requests radio resource allocation from the base station apparatus 1 using the TCH assigned for initial ranging (S112). The base station apparatus 1 performs FEC decoding or the like on the message for requesting radio resource allocation sent from the terminal apparatus PS1 before assigning an unoccupied TCH to the terminal apparatus 2. The base station apparatus 1 then includes, in an SCCH, the slot number and subchannel number of the TCH thus assigned and transmits the SCCH to the terminal apparatus 2 (S114). Since the synchronization of the TCH is achieved by this step, the base station apparatus 1 and terminal apparatus 2 will transmit data to each other using the synchronized TCH from then on (S116).

In the following, a modification will be described. As with the embodiment, the frequency of LCCH assignment within a unit time in a macrocell base station apparatus is defined to be higher than that in a microcell base station apparatus also in the modification. In the embodiment, the period of a BCCH, an IRCH, or a PCH for a macrocell base station apparatus is shorter than that for a microcell base station apparatus. In the modification, on the other hand, such a period is the same both for a microcell base station apparatus and a macrocell base station apparatus. Also, in the modification, multiple LCCHs for a single base station apparatus 1 are multiplexed. The communication system 20 according to the modification is of a similar type to the communication system 20 shown in FIG. 1, and the base station apparatus 1 according to the modification is of a similar type to the base station apparatus 1 shown in FIG. 7. Accordingly, a description will be given mainly of the differences therefrom.

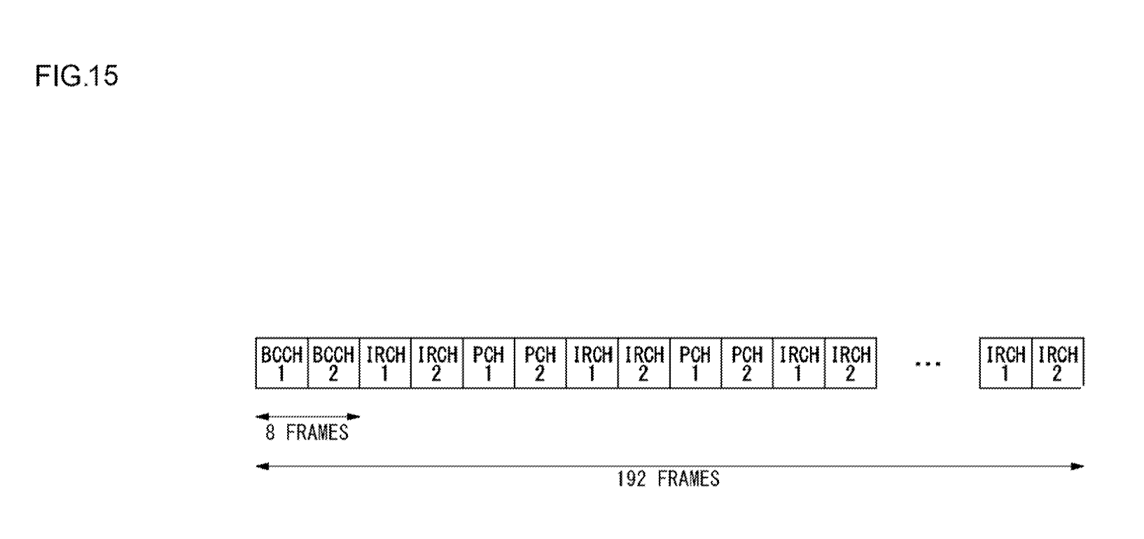

The ranging processing unit 110 in the first base station apparatus 1a determines the frequency of LCCH assignment so that it becomes less than the frequency of LCCH assignment in the second base station apparatus 1b. However, the ranging processing unit 110 in the first base station apparatus 1a has LCCHs multiplexed. FIG. 15 shows a configuration of a logical control channel according to the modification of the present invention, which corresponds to a configuration of an LCCH assigned by a macrocell base station apparatus. A BCCH consists of a BCCH1 and a BCCH2, and an IRCH and a PCH are also configured in similar ways. Each of a BCCH1 and the like consists of four frames. A unit of a BCCH1, an IRCH1, a PCH1, an IRCH1, a PCH1, and an IRCH1 corresponds to a repeat unit mentioned previously, and such a repeat unit is repeated four times to form a combination (hereinafter, referred to as a “first combination”). A BCCH1 and the nearest IRCH1 are eight frames apart.

Similarly, a unit of a BCCH2, an IRCH2, a PCH2, an IRCH2, a PCH2, and an IRCH2 also corresponds to a repeat unit mentioned previously, and this repeat unit is repeated four times to form another combination (hereinafter, referred to as a “second combination”). Furthermore, the first combination and the second combination form an LCCH. In other words, an LCCH consists of the first combination and the second combination that are time-multiplexed, and the period of the whole LCCH, i.e., 192 frames, is identical with the period of an LCCH assigned by a microcell base station apparatus. It is assumed here that the information included in the first combination and the second combination, particularly the information included in control signals for the downlink therein, is the same. Namely, time diversity is implemented using an LCCH. Aside from the example shown in FIG. 15, the ranging processing unit 110 may have the first combination and second combination multiplexed in units of frames. The description will now return to FIG. 7. The ranging processing unit 110 performs LCCH assignment as shown in FIG. 15.

According to the embodiment of the present invention, since a macrocell base station apparatus and a microcell base station apparatus assign control signals with different frequencies per unit time, the use efficiencies of frequencies can be controlled. Also, since the period of assigning control signals to a control channel in a macrocell base station apparatus is defined to be shorter than the period of assigning control signals in a microcell base station apparatus, the use efficiency of a control channel for a macrocell base station apparatus can be improved. Since the use efficiency of a control channel for a macrocell base station apparatus is improved, the use efficiencies of control channels for multiple types of base station apparatuses can be made close to each other. Further, since the period of assigning control signals to a control channel in a macrocell base station apparatus is defined to be an integer fraction of the period of assigning control signals in a microcell base station apparatus, the control can be simplified.

Also, since the period of assigning control signals to a control channel in a macrocell base station apparatus is defined to be the reciprocal of a power of two of the period of assigning control signals in a microcell base station apparatus, the control can be more simplified. Since control signals for a macrocell base station apparatus are multiplexed, the use efficiency of a control channel for a macrocell base station apparatus can be improved. Also, since control signals for a macrocell base station apparatus are multiplexed, the effect of time diversity can be obtained. Since the effect of time diversity is obtained, the communication quality can be improved. Further, since a control channel for a macrocell base station apparatus and a control channel for a microcell base station apparatus are provided on different subchannels, processing in terminal apparatuses can be simplified.

Since the first TCCH and IRCH are assigned to a frequency band to which cyclic signals, such as a BCCH and a PCH, are assigned and in which signals for multiple base station apparatuses are time-division multiplexed, a collision between TCCHs or a collision with a TCH for another base station apparatus can be prevented. Also, with such an arrangement, a dedicated subchannel for initial ranging will be unnecessary. Since a dedicated subchannel for initial ranging is unnecessary, the transmission efficiency can be improved. In addition, since multiple ranging processes are performed step by step, multiprocessing of TCCHs is enabled. Also, since multiple ranging processes are performed step by step, channels can be assigned to multiple terminal apparatuses. Further, since channel assignment processing is scheduled using time-division division multiplexing, channels can be assigned to multiple terminal apparatuses.

Also, since channel assignment processing is scheduled using time-division multiplexing, adaptive array transmission can be performed. In addition, since the first TCCH and IRCH are arranged between broadcasting signals, such as a BCCH and a PCH, the period of transmitting or receiving the first TCCH or IRCH can be reduced. Since the period of transmitting or receiving the first TCCH or IRCH is reduced, the period between the recognition of an incoming call via a PCH and the initiation of communication can be reduced. Since the period between the recognition of an incoming call via a PCH and the initiation of communication is reduced, the responsiveness to the incoming call can be improved. Also, since the period of transmitting or receiving the first TCCH or IRCH is reduced, channel assignment can be performed at a higher speed. Further, since a TCCH is arranged with respect to a BCCH, an IRCH, or a PCH, the opportunity of a terminal apparatus to transmit a TCCH can be increased. Since the opportunity of a terminal apparatus to transmit a TCCH is increased, the period of channel assignment processing can be reduced.

The present invention has been described with reference to the embodiment. The embodiment is intended to be illustrative only, and it will be obvious to those skilled in the art that various modifications to constituting elements or processes could be developed and that such modifications also fall within the scope of the present invention.

In the embodiment of the present invention, the communication system 20 includes two types of base station apparatuses 1, i.e., a macrocell base station apparatus and a microcell base station apparatus. However, applications are not limited thereto, and the communication system 20 may include three or more types of base station apparatuses 1, for example. When there are three types of base station apparatuses 1, these are considered as base station apparatuses 1 with “high”, “middle”, and “low” transmission power. When its transmission power is higher, the base station apparatus assigns control signals more frequently within a unit time. Therefore, according to this modification, the present invention can be applied to various types of communication systems 20.

In the embodiment of the present invention, a control channel for a macrocell base station apparatus and a control channel for a microcell base station apparatus are provided on different subchannels. However, applications are not limited thereto, and such control channels may be provided on the same subchannel. In this case, a BCCH or a PCH includes information for broadcasting the type of the base station apparatus 1. Based on the information, a terminal apparatus 2 determines whether the base station apparatus 1 is a macrocell base station apparatus or a microcell base station apparatus. Therefore, according to this modification, subcarriers designated as control channels can be reduced, thereby increasing frequency bands used for data transmission.

In the embodiment of the present invention, the ranging processing unit 110 includes the same information in the first combination and the second combination. However, applications are not limited thereto, and different pieces of information may be included in the first combination and the second combination. As stated previously, an LCCH consists of four repeat units. In this modification, the four repeat units are called, from top to bottom, a “first repeat unit”, a “second repeat unit”, a “third repeat unit”, and a “fourth repeat unit”. When including the “first repeat unit” in the first combination, the ranging processing unit 110 may include the “second repeat unit” in the second combination. Thereafter, when including the “third repeat unit” in the subsequent first combination, the ranging processing unit 110 includes the “fourth repeat unit” in the subsequent second combination. Therefore, according to this modification, the period of an LCCH can be reduced. In addition, a terminal apparatus 2 can comprehend the details of an LCCH in a short period.

### INDUSTRIAL APPLICABILITY

The present invention allows the use efficiencies of control channels for multiple types of base station apparatuses to be close to each other.

1. A base station apparatus, which is either of at least two types of base station apparatuses defined in a predetermined communication system, the base station apparatus comprising:
an assigning unit configured to cyclically assign control signals, the frequency of assigning control signals per unit time in the assigning unit being different from the frequency of assigning control signals per unit time in another type of base station apparatus;
a broadcasting unit configured to broadcast a control signal assigned by the assigning unit; and
a communication unit configured to perform communication with a terminal apparatus that has received a control signal broadcasted by the broadcasting unit.

2. The base station apparatus of claim 1, wherein the assigning unit determines the period of assigning control signals so that the period becomes shorter than the period of assigning control signals in another type of base station apparatus.

3. The base station apparatus of claim 2, wherein the assigning unit determines the period of assigning control signals so that the period becomes an integer fraction of the period of assigning control signals in another type of base station apparatus.

4. The base station apparatus of claim 1, wherein the assigning unit determines the frequency of assigning control signals so that the frequency becomes less than the frequency of assigning control signals in another type of base station apparatus and the unit has control signals multiplexed.

5. The base station apparatus of claim 1, wherein the broadcasting unit broadcasts a control signal on a frequency different from that on which another type of base station apparatus broadcasts a control signal.

6. The base station apparatus of claim 1, wherein the broadcasting unit broadcasts a control signal with transmission power different from that with which another type of base station apparatus broadcasts a control signal.

7. A communication system, comprising:
a first base station apparatus defined in a predetermined communication system; and
a second base station apparatus defined in the same communication system in which the first base station apparatus is defined, the frequency of assigning control signals per unit time in the second base station apparatus being different from the frequency of assigning control signals per unit time in the first base station apparatus.

8. A communication method, comprising:
assigning control signals cyclically in either of at least two types of base station apparatuses defined in a predetermined communication system, the frequency of assigning control signals per unit time in the assigning being different from the frequency of assigning control signals per unit time in another type of base station apparatus;
broadcasting an assigned control signal; and
performing communication with a terminal apparatus that has received a broadcasted control signal.
